(19) United States
(12) Patent Application Publication
(10) Pub. No.: US 2013/0003664 A1
(43) Pub. Date: Jan. 3, 2013

(54) Scheduling of a User Equipment in a Radio Communication System

(75) Inventors: Mattias Frenne, Uppsala (SE); Robert Baldemair, Solna (SE); Jung-Fu Cheng, Fremont, CA (US); Dirk Gerstenberger, Stockholm (SE); Daniel Larsson, Solna (SE); Stefan Parkvall, Stockholm (SE)

(73) Assignee: TELEFONAKTIEBOLAGET LM ERICSSON (PUBL), Stockholm (SE)

(21) Appl. No.: 13/318,226

(22) PCT Filed: Jun. 28, 2011
(86) PCT No.: PCT/SE11/50856

§ 371 Date: Oct. 31, 2011

(51) Int. Cl. H04W 72/04

(52) U.S. Cl. 370/329

(57) ABSTRACT

A radio base station (110) and a method in a radio base station (110) for scheduling a transmission to be transmitted between a user equipment (120) and the radio base station (110) are provided. Moreover, a user equipment (120) and a method in a user equipment (120) for obtaining information about the transmission are provided. The radio base station (110) operates an aggregated carrier in a subframe structure comprising a plurality of subframes. The aggregated carrier comprises a plurality of carriers. The radio base station (110) encodes information about a subframe out of said plurality of subframes and a carrier out of said plurality of carriers into a message indicating scheduling information to the user equipment (120). The radio base station (110) sends the message to the user equipment (120), which decodes the message to obtain the information about the transmission. The information about the transmission is indicative of the subframe and the carrier on which the transmission is scheduled.

### TECHNICAL FIELD

The present disclosure relates to the field of telecommunication. More particularly, the present disclosure relates to a radio base station and a method in a radio base station for scheduling a transmission to be transmitted between the radio base station and a user equipment. Furthermore, the present disclosure relates to a user equipment and a method in a user equipment for obtaining information about a transmission to be transmitted between the user equipment and the radio base station.

### BACKGROUND

In order to meet the upcoming International Mobile Telecommunications Advanced (IMT-Advanced) requirements, the Third Generation Partnership Project (3GPP) has initiated work on Long Term Evolution Advanced (LTE-Advanced). One of the parts of LTE-Advanced is to support bandwidths larger than 20 MHz. One important requirement on LTE-Advanced is to assure backward compatibility with LTE Release 8 (Rel-8). This should also include spectrum compatibility. The LTE Rel-8 standard supports bandwidths up to 20 MHz. That would imply that an LTE-Advanced carrier, wider than 20 MHz, should appear as a number of LTE carriers to an LTE Rel-8 terminal. Each such carrier can be referred to as a component carrier (CC). In particular for early LTE-Advanced deployments, it can be expected that there will be a smaller number of LTE-Advanced-capable terminals compared to many LTE legacy terminals. Therefore, it is necessary to assure an efficient use of a wide carrier also for legacy terminals, i.e. that it is possible to implement carriers where legacy terminals can be scheduled in all parts of the wideband LTE-Advanced carrier. The straightforward way to obtain this would be by means of carrier aggregation. Carrier aggregation implies that an LTE-Advanced terminal can receive multiple component carriers, where the component carriers have, or at least the possibility to have, the same structure as a Rel-8 carrier.

The number of aggregated component carriers as well as the bandwidth of the individual component carrier may be different for uplink and downlink. A symmetric configuration refers to a first case in which the number of component carriers in downlink and uplink is the same whereas an asymmetric configuration refers to a second case in which the number of component carriers in downlink and uplink is different. Notable, the number of component carriers configured in a cell may be different from the number of component carriers seen by a terminal. That is a terminal may for example support more downlink component carriers than uplink component carriers, even though the cell is configured with the same number of uplink and downlink component carriers.

Scheduling of the component carriers is done on a Physical Downlink Control Channel (PDCCH) via downlink assignments. Uplink grants are also signalled via PDCCH. Control information, such as scheduling information, transmission information and the like, on the PDCCH is formatted as a Downlink Control Information (DCI) message. DCI messages for downlink assignments comprises for example a resource block assignment, modulation and coding scheme related parameters, Hybrid Automatic Repeat Request (hybrid-ARQ) redundancy version, etc. In addition to those parameters that relate to the actual downlink transmission most DCI formats for downlink assignments also contain a bit field for Transmit Power Control (TPC) commands. These TPC commands are used to control the uplink power control behaviour of a Physical Uplink Control Channel (PUCCH), corresponding to the PDCCH. The PUCCH is used to transmit the hybrid-ARQ feedback.

The design of PDCCH in LTE Rel-10 follows very much that one in Rel-8/9. Assignments and grants of each component carrier are separately encoded and transmitted within a separate PDCCH. Main motivation for choosing separately encoded PDCCH over a jointly encoded PDCCH—here DCI messages from multiple component carriers would be lumped together into one entity, jointly encoded and transmitted in a single PDCCH—was simplicity.

In LTE Rel-10, the PDCCH is extended to include a Carrier Indicator Field (CIF), which is not present in LTE Rel-819. The CIF may consist of three bits included in the DCI message which points to the component carrier which carries the shared channel corresponding to the DCI. For a downlink assignment the CIF points to the component carrier carrying the PDSCH whereas for an uplink grant the three bits are used to address the component carrier conveying Physical Uplink Shared Channel (PUSCH). Thanks to the CIF one carrier may be used for cross-scheduling of another carrier.

In a known scenario, a telecommunication system comprises a macro base station and a pico base station. The telecommunication system is commonly referred to as being a Heterogeneous network (HetNet). The macro base station operates an aggregated carrier comprising at least a first and a second carrier. The pico base station also operates on the aggregated carrier. In order to reduce interference towards user equipments (UEs) served by the pico base station, transmission of the macro base station is restricted. Schemes for restricting the transmission, such as almost blank subframes (ABS) or the like, from the macro base station are known in the art. There is a fixed relation between uplink grants and a transmission corresponding thereto and downlink assignments relate to the subframe in which it is transmitted. Hence, due to that the macro base station is not allowed to transmit on any subframe, some subframes may not be scheduled at all.

In another known scenario, a radio base station operates an aggregated carrier comprising a first and a second carrier with different uplink/downlink configurations. As a further example, the first carrier may be configured for Frequency Division Duplex (FDD) and the second carrier may be configured for Time Division Duplex (TDD). As an example, the first carrier may have only one downlink subframe per radio frame. Thus, the PDCCH can only be transmitted in said only one downlink subframe. In case, the PDCCH is transmitted on the first carrier, the radio base station can only schedule some of the subframes of the radio frame.

Furthermore, with increased number of scheduled user equipments in a radio communication system, the PDCCH may become a bottleneck of the system. In particular, this may happen when bursty traffic patterns occur, i.e. if in a certain subframe many user equipments need to be scheduled in parallel. In some cases, the number of available PDCCH in that subframe will not be sufficient to include scheduling information for those user equipments that is required to be scheduled. This may lead to PDCCH congestion.

### SUMMARY

An object is to provide a scheduling method which improves performance, such as in terms of throughput and/or delays, of a telecommunication system, such as an LTE system.

According to an aspect, the object is achieved by a method in a radio base station for scheduling a transmission to be transmitted between a user equipment and the radio base station. The radio base station operates an aggregated carrier in a subframe structure comprising a plurality of subframes. The aggregated carrier comprises a plurality of carriers on which the user equipment is served. The radio base station encodes information about a subframe out of said plurality of subframes and a carrier out of said plurality of carriers into a message indicating scheduling information to the user equipment. Thereby, the transmission is scheduled on the subframe and the carrier. The radio base station sends the message to the user equipment.

According to another aspect, the object is achieved by a radio base station for scheduling a transmission to be transmitted between a user equipment and the radio base station. The radio base station is configured to operate an aggregated carrier in a subframe structure comprising a plurality of subframes. The aggregated carrier is configured to comprise a plurality of carriers for serving the user equipment. The radio base station comprises a scheduler configured to encode information about a subframe out of said plurality of subframes and a carrier out of said plurality of carriers into a message indicating scheduling information to the user equipment. Thereby, the scheduler is configured to schedule the transmission on the subframe and the carrier. Furthermore, the radio base station comprises a transmitter configured to send the message to the user equipment.

According to a further aspect, the object is achieved by a method in a user equipment for obtaining information about a transmission to be transmitted between the user equipment and a radio base station. The user equipment 120 is served on an aggregated carrier in a subframe structure comprising a plurality of subframes. The aggregated carrier comprises a plurality of carriers. The user equipment receives, from the radio base station, a message indicating scheduling information to the user equipment. Next, the user equipment decodes the message to obtain the information about the transmission. The information is indicative of a subframe out of said plurality of subframes and a carrier out of said plurality of carriers. The transmission is scheduled on the subframe and the carrier.

According to yet another aspect, the object is achieved by a user equipment for obtaining information about a transmission to be transmitted between the user equipment and a radio base station. The user equipment is configured to be served on an aggregated carrier in a subframe structure comprising a plurality of subframes. The aggregated carrier is configured to comprise a plurality of carriers. The user equipment comprises a receiver configured to receive, from the radio base station, a message indicating scheduling information. Moreover, the user equipment comprises a processing circuit configured to decode the message to obtain the information about the transmission. The information is indicative of a subframe out of said plurality of subframes and a carrier out of said plurality of carriers. The transmission is scheduled on the subframe and the carrier.

Generally, embodiments herein provide a solution for scheduling a transmission to be transmitted between the user equipment (UE) and the radio base station, such as an evolved-NodeB. The radio base station encodes information about a subframe out of a plurality of subframes and a carrier out of a plurality of carriers into a message indicating scheduling information to the user equipment. Thereby, the transmission is scheduled on the subframe and the carrier. In this manner, the message specifies both the subframe and the carrier for which the scheduling information, indicated by the message, applies. Thus, scheduling is made flexible in terms of which carrier and which subframe the transmission may be scheduled on.

Next, the user equipment decodes the message to obtain the information about the transmission.

In this manner, the radio base station may schedule the user equipment in both uplink and downlink to any carrier and any subframe. Thereby, the radio base station now is able to schedule subframes that previously were unused during certain circumstances. Furthermore, the scheduler is given a flexibility to schedule the user equipment to a given carrier and a given subframe out of multiple downlink subframes. Thereby, flexibility of the scheduler is increased and PDCCH congestion may be reduced. As a result, the above mentioned object is achieved.

In some embodiments, the message comprises a string of bits indicating a combination of the subframe and the carrier. This is more efficient than encoding the subframe and the carrier separately.

In some embodiments, the message may be a downlink control information message (DCI message) comprising an indicator field, such as a Carrier Indicator Field. The indicator field may comprise at least a portion of the string of bits.

Thanks to increased flexibility in the scheduler of the radio base station, it is made possible to schedule a larger amount of simultaneous users. In this manner, higher system throughput and smaller delays for each user may be obtained.

Furthermore, the present solution makes it possible to schedule all possible subframes in case of carrier aggregation of TDD carriers with different uplink/downlink configurations for the different carriers or aggregation of both FDD and TDD carriers.

In HetNet operation in which carrier aggregation is employed, embodiments herein may avoid PDCCH congestion on the carrier on which the radio base station transmits control information.

### BRIEF DESCRIPTION OF THE DRAWINGS

The various aspects of embodiments disclosed herein, including particular features and advantages thereof, will be readily understood from the following detailed description and the accompanying drawings, in which:

FIG. 1 shows a schematic overview of an exemplifying radio communication system in which exemplifying methods according embodiments herein may be implemented,

FIG. 2 shows a schematic combined signalling and flow chart of exemplifying methods in the radio communication system according to FIG. 1,

FIG. 3 shows exemplifying carriers with CIF enabled,

FIG. 4 shows exemplifying PDCCH indicating different subframes in two carriers according to a first example,

FIG. 5 shows exemplifying PDCCH indicating different subframes in two carriers according to a second example,

FIG. 6 shows exemplifying PDCCH indicating different subframes in two carriers according to a third example,

FIG. 7 shows a schematic flow chart of the exemplifying methods of FIG. 2 when seen from the radio base station,

FIG. 8 shows a schematic block diagram of exemplifying radio base stations configured to perform the methods illustrated in FIG. 7,

FIG. 9 shows a schematic flow chart of the methods of FIG. 2 when seen from the user equipment,

FIG. 10 shows a schematic block diagram of exemplifying user equipments configured to perform the method illustrated in FIG. 9,

FIG. 11 schematically illustrates LTE physical resource elements,

FIG. 12 schematically illustrates an LTE subframe structure, such as a time-domain structure,

FIG. 13 schematically illustrates a downlink subframe;

FIG. 14 illustrates schematically a PUSCH resource assignment;

FIG. 15 illustrates carrier aggregation,

FIG. 16 illustrates cell range expansion, and

FIG. 17 shows an exemplifying HetNet.

### DETAILED DESCRIPTION

Throughout the following description similar reference numerals have been used to denote similar elements, network nodes, parts, items or features, when applicable. In the Figures, features that appear in some embodiments are indicated by dashed lines.

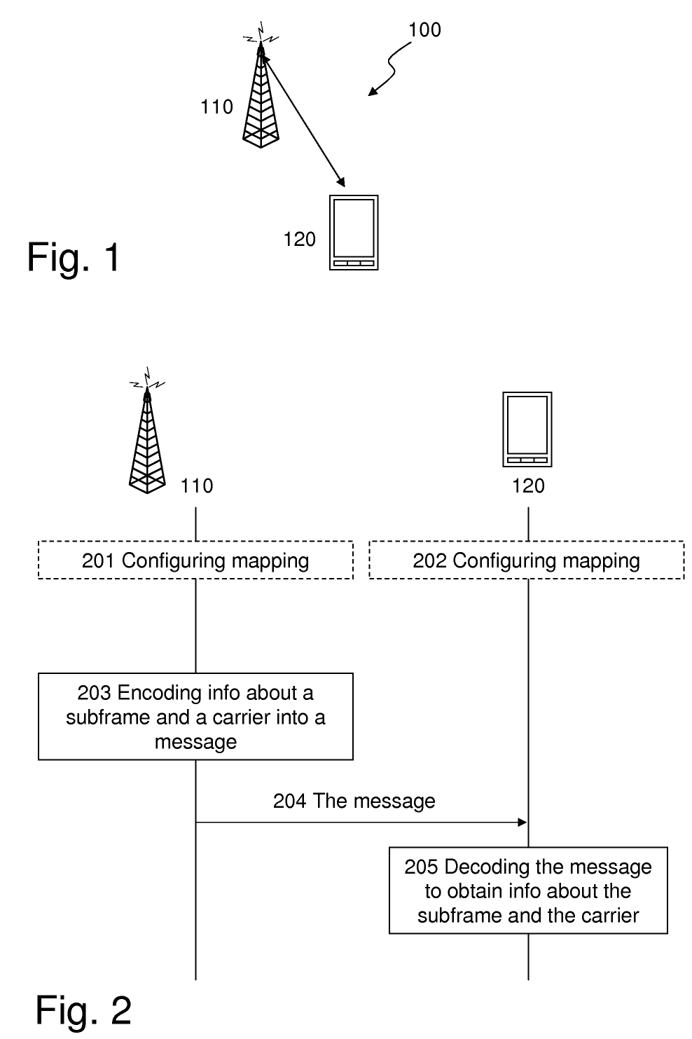

In FIG. 1, a schematic overview of an exemplifying radio communication system 100 is shown. Exemplifying methods according embodiments described herein may be implemented in the radio communication system 100. As an example, the radio communication system 100 is a LTE system. In other examples, the radio communication system 100 may be an evolution of the LTE system 100, i.e. a radio communication system using the same basic principles as regards features relevant to the present solution.

The radio communication system 100 comprises a radio base station 110, such as an evolved-NodeB (eNodeB, eNB).

Moreover, FIG. 1 illustrates a user equipment 120. The user equipment 120 is configured for communication with the radio base station 110 within the LTE system 100. As used herein, the term “user equipment” may denote a mobile phone, a cellular phone, a mobile terminal, a terminal equipped with radio communication capabilities, a Personal Digital Assistant (PDA) equipped with radio communication capabilities, a smart phone, a laptop equipped with an internal or external mobile broadband modem, a portable electronic radio communication device, a wireless transceiver unit or the like.

According to one exemplifying non-limiting embodiment, the use of CIF is extended so that a subframe n can be assigned or granted to the user equipment 120 in different time occasion than n for downlink assignments or n+k for uplink grants. k is 4 for FDD and given by table 8-2 in 3GPP TS 36.213 V10.1.0 Physical layer procedures. This is achieved by changing the meaning, or interpretation, of the CIF such that some of the eight combinations (3 bits) refer to the time domain and some to the frequency domain. Alternatively or additionally, each combination of the eight combinations refers to a combination of a time domain reference, such as a subframe, subframe number or the like, and a frequency domain reference, such as a carrier, component carrier, frequency band or the like. Cross-scheduling in the time domain may be referred to as cross-subframe scheduling and cross-scheduling in the frequency domain may be referred to as cross-carrier scheduling.

Now turning to FIG. 2, a schematic combined signalling and flow chart of exemplifying methods in the radio communication system 100 according to FIG. 1 is shown. The radio base station 110 performs a method for scheduling a transmission to be transmitted between the user equipment 120 and the radio base station 110. The radio base station 110 operates an aggregated carrier in a subframe structure comprising a plurality of subframes. As an example, the subframe structure may be a time structure as shown in FIG. 12. The aggregated carrier comprises a plurality of carriers. The user equipment 120 is served on the aggregated carrier, i.e. on said plurality of carriers.

In some embodiments, the radio base station 110 further operates a plurality of cells. Each cell is operated on a respective carrier of said plurality of carriers. The user equipment 120 is served by said plurality of cells.

In some examples, the aggregated carrier is operated by the radio base station 110 in that the radio base station 110 provides said plurality of carriers, such as component carriers. The user equipment 120 may use one or more of the carriers provided by the radio base station 110, i.e. the user equipment 120 is served by said plurality of cells, each corresponding to a respective carrier of said plurality of carriers. When the radio base station 110 operates the aggregated carrier, it also operates on said plurality of carrier, i.e. also on the aggregated carrier.

In some embodiments, the transmission is an uplink transmission to be transmitted by the user equipment 120 and to be received by the radio base station 110.

In some embodiments, the transmission is a downlink transmission to be transmitted by the radio base station 110 and to be received by the user equipment 120.

The following actions may be performed. Notably, in some embodiments of the method the order of the actions may differ from what is indicated below.

### Action 201

In some embodiments, the radio base station 110 configures mapping from a string of bits to the combination of the subframe and the carrier. As will be explained in more detail with reference to Table 1 and 2, the radio base station 110 may load tables indicating available combinations of subframe and carrier.

Therefore, according to some embodiments, the mapping, or interpretation, of the CIF is not fixed by the specifications. Instead, the mapping may be configured. Typically, RRC signalling may be used to configure the mapping, i.e. to fill in the second and third column of Table 1 and/or 2 with appropriate values. According to some embodiments, the configured mapping, or interpretation, depends on the subframe number n. The mapping may for example in some subframe not include a possibility to do cross-subframe scheduling or cross-carrier scheduling, whereas in other subframes this is possible.

### Action 202

In some embodiments, the user equipment 120 configures mapping from the string of bits to the subframe and the carrier. The mapping may for example be received from the radio base station 110, be preconfigured according to standard tables and/or the like. See also Table 1 and/or 2.

### Action 203

The radio base station 110 encodes information about a subframe out of said plurality of subframes and a carrier out of said plurality of carriers into a message indicating scheduling information to the user equipment 120. In this manner, the message, such as a DCI message, specifies a subframe and a carrier for which the scheduling information applies. Thereby, scheduling is made more flexible. As an example, the scheduling information may comprise a specific DCI format, transport block size, modulation and coding scheme, transport format, etc.

By specifying the subframe and the carrier, the transmission is scheduled on said subframe and said carrier.

In some embodiments, the message comprises a string of bits indicating a combination of the subframe and the carrier. This is more efficient than encoding the subframe and the carrier separately.

In some embodiments, the message is a downlink control information message comprising an indicator field, such as CIF, and at least a portion of the string of bits is encoded into the indicator field.

In some embodiments, the message comprises a checksum and at least a portion of the string of bits is encoded into the checksum.

In some embodiments, a specific user equipment identifier, such as an Radio Network Temporary Identifier (RNTI), is used to encode said at least a portion of the string of bits into the checksum.

Hence, the string of bits may according to some embodiments be encoded by the use of the specific user equipment identifier and the indicator field. As an example, the indicator field may be used to indicate the subframe and the specific user equipment identifier may be used to indicate the carrier.

As an example, a Cyclic Redundancy Check (CRC) value, such as the checksum above, of a DCI message (DCI message CRC) is scrambled with a specific RNTI or code point that gives which subframe in time the corresponding downlink assignment or uplink grant is valid for. More generally, it can be envisioned that the DCI message CRC can be scrambled with M_{scramb} different scrambling codes thus conveying log 2(M_{scramb}), the total number of bits (in CIF but DCI message CRC scrambling) is then the number of bits if the CIF plus log 2(M_{scramb}). Instead of scrambling M_{scramb} different CRC polynomials could be used, however, this method is less preferable since complexity increases.

Herein it is assumed that the CIF comprises 3 bits. But if it is in the user equipment specific search space the number of CIF could be changed if not enough CIF code points exists to cover all carriers and subframes. Furthermore, PDCCH scrambling may be used to increase the number of code points.

In some embodiments, in which the message is a DCI message, a further bit field may be added to an existing DCI format. Such further bit field indicates which subframe the downlink assignment or uplink grant is valid for on a cross-scheduled carrier. The cross-scheduled carrier is indicated by the CIF.

### Action 204

The radio base station 110 sends and the user equipment 120 receives the message. As an example, the message is sent on PDCCH. The message may be indicating scheduling information to the user equipment 120. As an example, the scheduling information is used by the user equipment 120 for determining when and how a downlink transmission is to be received. As another example, the scheduling information is used by the user equipment 120 for determining when and how an uplink transmission is to be transmitted.

### Action 205

The user equipment 120 decodes the message to obtain the information about the transmission. The information is indicative of a subframe out of said plurality of subframes and a carrier out of said plurality of carriers. The transmission is scheduled on said subframe and said carrier.

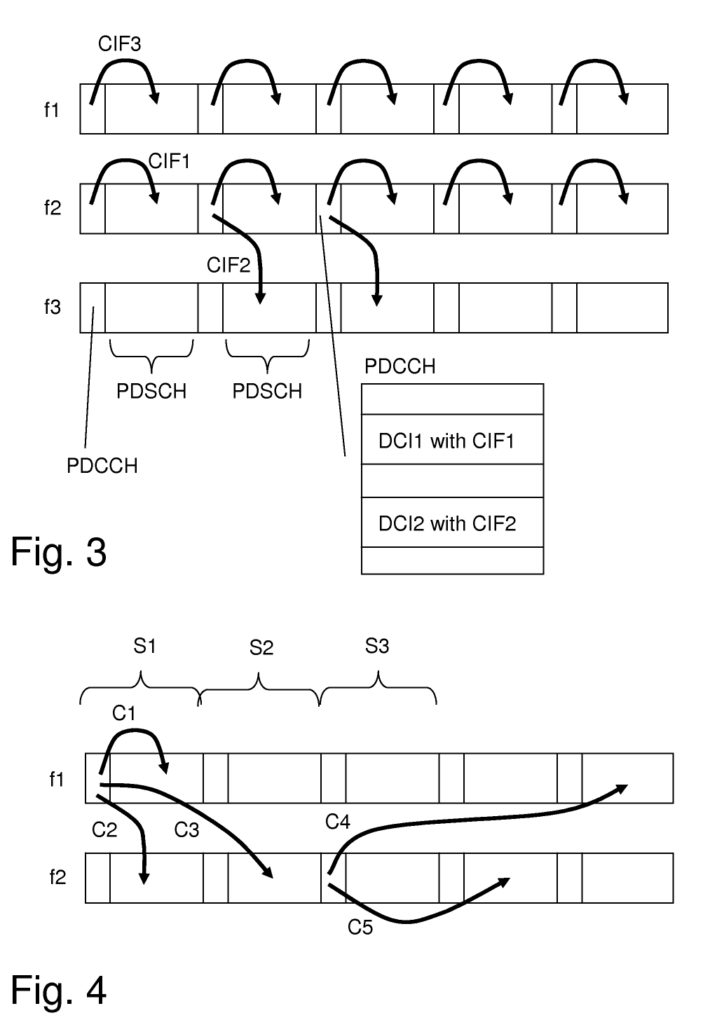

In order to better appreciate the benefits of the embodiments disclosed herein, FIG. 3 shows a set of exemplifying carriers with CIF enabled. In this context, the CIF is used only to indicate which carrier comprises, or carries, PDSCH corresponding to the transmitted PDCCH. This is hence the way CIF is used according to prior art. In FIG. 3, a first, a second and a third carrier f1, f2, f3 are shown. In the first carrier f1, a third carrier indicator field CIF3 is shown. On one hand, it is shown that the first carrier is only scheduling resources within the first carrier, i.e. no cross-scheduling. On the other hand, it is shown that the second carrier f2 schedules both resources within the second carrier f2 and resources within the third carrier f3. A first carrier indicator field CIF1 is used for scheduling of resources within the second carrier f2. For cross-scheduling of the third carrier f3, a second carrier indicator field CIF2 is used. In this example, the CIFs, i.e. CIF1, CIF2 and CIF3, are pointing to the PDSCH corresponding to the PDCCH. As may be understood from the enlarged view of the third PDCCH in the third subframe from the left (indication of subframes is shown in FIG. 4), the PDCCH may carry for example a first downlink control information DCI1 and a second downlink control information DCI2.

FIG. 4 shows exemplifying PDCCH indicating different subframes in two carriers according to a first example. In the first example, the first carrier f1 cross-schedules the second carrier f2 in a first subframe S1. It may be seen that a first arrow C1 and a second arrow C2 point to the expected PDSCH. A third arrow C3 points to a PDSCH which could not be scheduled with the methods according to prior art. However, the present solution provides means for specifying that the PDCCH corresponds to a PDSCH in a second subframe S2. In a third subframe S3, the second carrier f2 cross-schedules the first carrier f1. Here, the PDCCH in the third subframe S3 corresponds to PDSCH in the right most subframe of the first carrier.

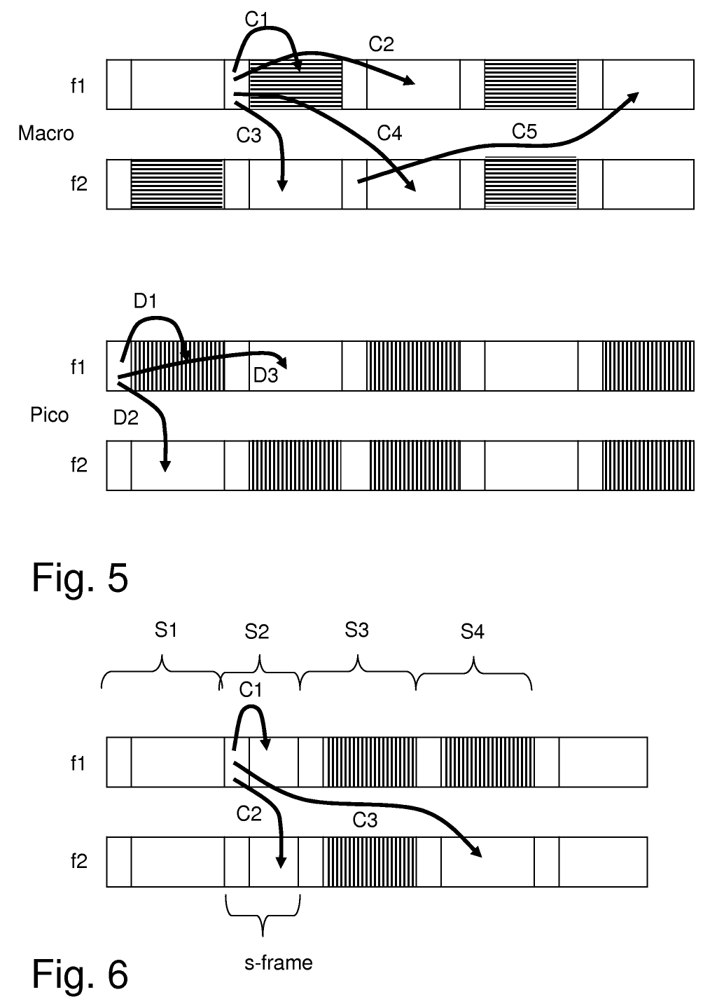

FIG. 5 shows exemplifying PDCCH indicating different subframes in two carriers according to a second example. In the second example, a macro base station, denoted macro, and a pico base station, denoted pico, are comprised in a HetNet. The macro base station operates a first and a second carrier f1, f2. Likewise, the pico base station operates on the first and second carriers f1, f2. In order to reduce interference from the macro base station, transmissions from the macro base station is restricted as shown by subframes in solid white. Solid white subframes for the pico base station denotes subframes for which corresponding PDCCH may be heavily interfered by the macro base station. Subframes being partly horizontally striped denote subframes, eg. PDSCH, for which interference towards the pico is quite heavy. The solid white subframes of the pico base station corresponds to the horizontally striped subframes of the macro base station. Subframes being partly vertically striped denote subframes of the pico base station for which PDCCH is less interfered by the macro base station due to the restriction of transmission therefrom. Hence, the subframes being partly vertically striped corresponds to the solid while subframes of the macro base station. A purpose of restricting transmission of the macro is to make it easier for a user equipment, served by the pico base station, to receive and decode control information, such as PDCCH, from the pico base station. Thus, some transmission of data on PDSCH in subframes marked as solid white may be tolerable. According to prior art, PDCCH for subframes pointed at by arrows C2 and C3 may be achieved. With the present solution also a fourth arrow C4 for providing PDCCH for transmission of data in the subframe pointed at by the fourth arrow C4 is made possible. This also applies for a fifth arrow C5. Note that the interpretation of the message that specifies the carrier and the subframe may be different for the next subframe scheduling opportunity in this example since the available carriers and subframes relative to the subframe where the PDCCH is transmitted is different from those in the current subframe (as indicated by the arrows).

FIG. 6 shows exemplifying PDCCH indicating different subframes in two carriers operated by a radio base station according to a third example. In this example, carrier aggregation of TDD carriers, potentially with different uplink/downlink configurations, or uplink/downlink allocations, is employed. In FIG. 6, aggregation of a first carrier f1 with a first uplink/downlink (UL/DL) configuration and a second carrier f2 with a second UL/DL configuration is shown. In this example, the PDCCH of one carrier may be interfered by the transmission from the other carrier since the uplink/downlink configurations are different for the first and second carriers. A special subframe, denoted S-frame, is always present before an uplink subframe when there has been a switch from a downlink subframe. White subframes denote downlink transmissions and vertically striped subframes denote uplink transmissions. A fourth subframe S4 of the second carrier f2 can not be scheduled according to prior art, for example since cross-scheduling from the first carrier f1 is not possible due to that the fourth subframe S4 of the first carrier is an uplink subframe. Thus, as shown by a third arrow C3, the fourth subframe S4 is cross-scheduled in time and frequency from a second subframe S2 being a so called special subframe.

According to the above, the present solution provides a flexible method for scheduling a transmission. In particular, the present solution enables scheduling of the transmission on subframes and/or carriers which could not be scheduled with methods according to prior art.

In the following, a detailed description of how the string of bits may be mapped to a specific subframe and a specific carrier is provided. In the following examples, it is assumed that a CIF of three bits is used for indicating the specific subframe and the specific carrier for a downlink (DL) assignment or an uplink (UL) grant. Some of the bits in the CIF field are used to indicate the applicable subframe in time for the DL assignment or UL grant. Out of the remaining bits, some bits can be used to indicate the carrier to which the DL assignment or UL grant refers. It is not necessary to use all bits, e.g. it is possible to use only two bits, one for subframe indication and one bit for carrier indication.

For example, assuming one bit for subframe indication and two bits for carrier indication, the CIF is interpreted as follows: a value of 0 for the bit that indicates the applicable subframe in time has the following meaning
For FDD
   DL assignment is valid for subframe n
   UL grant is valid for subframe n+4
For TDD
   DL assignment is valid to subframe n
   UL grant is valid to subframe n+k, where k is defined in by table 8-2 in 3GPP TS 36.213 V10.1.0 Physical layer procedures.
      In case the value instead is a 1 it has the following meaning
For FDD
   DL assignment is valid to subframe n+1
   UL grant is valid to subframe n+5
For TDD
   DL assignment is valid to the next available DL subframe or Special subframe after subframe n that contains PDSCH
   UL grant is valid to next available UL subframe after n+k, where k is defined in table 8-2 in 3GPP TS 36.213 V10.1.0 Physical layer procedures.

It is evident to a person skilled in the art that this is an example and that other possibilities in interpretation of the bits can be used. For example, the values +1 and +5 for FDD could be replaced by other numbers.

In a similar manner it is also possible to reserve two bits to indicate which subframe in time the DL assignment or the UL grant is valid for. In such a case if total number of bits for the CIF is 3, it will only be possible to address 2 carriers. The same principle as above will then follow but instead it is possible to schedule the user equipment in the current subframe, next available subframe, third available subframe and the fourth available subframe.

In the general case, time (inter-subframe) and frequency (cross-carrier) indication does not have to be restricted to separate bits. Instead, each of the CIF values could refer to a certain component carrier in the frequency domain and a certain subframe in the time domain. Hence, the CIF value may refer to a combination of the certain component carrier and the certain subframe. In this manner, a fewer number of bits may be needed as compared to separately encoding the component carrier and the subframe into different portions of the CIF. An example is provided in Table 1 on the last page of the drawing sheets. In this example, where the downlink PDSCH in an FDD system is illustrated, three different component carriers are used. The value in the second column indicates which component carrier the assignment (or grant in case of uplink scheduling) relates to. The value in the third column indicates to which subframe n+k a assignment received in subframe n is valid. Clearly, the numbers are given for illustrative purposes only. Furthermore, the subframe offset k may, in case of TDD, depend on the subframe number n in which the assignment/grant is received in a similar way as for Table 8-2 in 3GPP TS 36.213 V10.1.0 Physical layer procedures.

It is further possible to combine the above aspects, e.g. to reserve a subset of the CIF bits to indicate one of (time or frequency) and another subset of the CIF bits to indicate combinations of time and frequency.

Different tables such as Table 1 may be applied for different component carriers upon which the PDCCH is received.

Moreover, it shall be understood that different tables, such as Table 1, may be used depending on in which subframe the PDCCH is transmitted. At most, there may be 10 different tables, i.e. one table for each subframe of a radio frame. As may be seen from for example FIG. 6, the number of frames available for scheduling may differ with the number of the subframe. For example, when the next subframe is an uplink subframe it is not possible to schedule a downlink transmission to said uplink subframe.

Turning to Table 2, an exemplifying mapping from CIF to carrier, i.e. component carrier and subframe is shown. Table 2 applies to a case where carrier aggregation with different UL/DL allocations, or configurations, is employed. The numbers k1, k2 and k3 are the subframe offset between the PDCCH reception, i.e. subframe n, and PDSCH reception, i.e. subframe n+k1/k2/k3. k1 applies to a first carrier, k2 applies to a second carrier and so on. Due to different UL/DL allocations the k-values, such as k1, k2, k3, may vary across aggregated carriers. In the right most column, the expression “next after” and “second next after” refers to the next possible downlink subframe. The k-values may even depend on the subframe n in which PDCCH is received in.

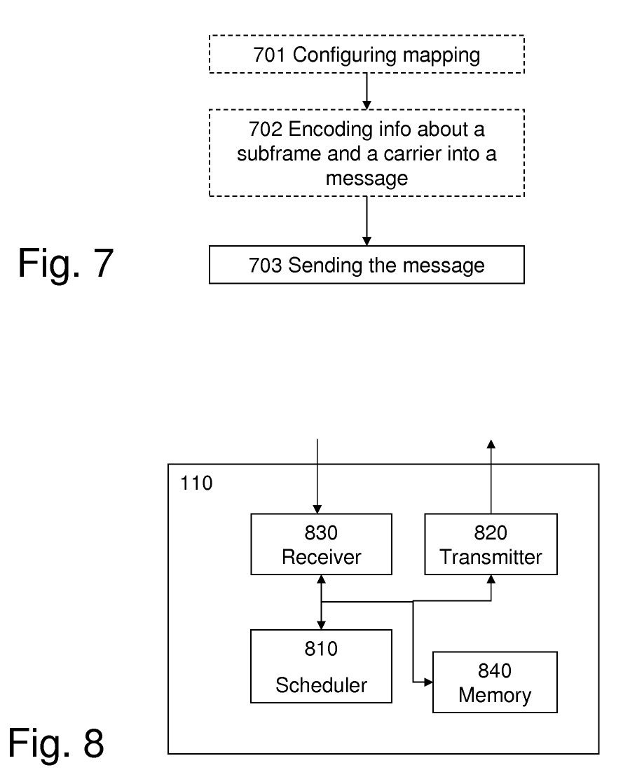

Now turning to FIG. 7, an exemplifying, schematic flow chart is shown. The exemplifying flow chart illustrates the methods of FIG. 2 when seen from the radio base station 110. As mentioned above, the radio base station 110 may perform a method for scheduling a transmission to be transmitted between a user equipment 120 and the radio base station 110. As mentioned above, the radio base station 110 operates an aggregated carrier in a subframe structure comprising a plurality of subframes. Also as mentioned, the aggregated carrier comprises a plurality of carriers on which the user equipment 120 is served.

The following actions may be performed. Notably, in some embodiments of the method the order of the actions may differ from what is indicated below.

### Action 701

This action corresponds to action 201.

In some embodiments, the radio base station 110 configures mapping from the string of bits to the combination of the subframe and the carrier. As will be explained in more detail with reference to Table 1 and 2, the radio base station 110 may load tables indicating available combinations of subframe and carrier.

Therefore, according to some embodiments, the mapping, or interpretation, of the CIF is not fixed by the specifications. Instead, the mapping may be configured. Typically, RRC signalling may be used to configure the mapping, i.e. to fill in the second and third column of Table 1 and/or 2 with appropriate values.

### Action 702

This action corresponds to action 203.

The radio base station 110 encodes information about a subframe out of said plurality of subframes and a carrier out of said plurality of carriers into a message indicating scheduling information to the user equipment 120. In this manner, the message, such as a DCI message, specifies a subframe and a carrier for which the scheduling information applies. Thereby, scheduling is made more flexible. As an example, the scheduling information may comprise a specific DCI format, transport block size, modulation and coding scheme, transport format, etc.

By specifying the subframe and the carrier, the transmission is scheduled on said subframe and said carrier.

In some embodiments, the message comprises a string of bits indicating a combination of the subframe and the carrier. This is more efficient than encoding the subframe and the carrier separately.

In some embodiments, the message is a downlink control information message comprising an indicator field, such as CIF, and at least a portion of the string of bits is encoded into the indicator field.

In some embodiments, the message comprises a checksum and at least a portion of the string of bits is encoded into the checksum.

In some embodiments, a specific user equipment identifier, such as an Radio Network Temporary Identifier (RNTI), is used to encode said at least a portion of the string of bits into the checksum.

Hence, the string of bits may according to some embodiments be encoded by the use of the specific user equipment identifier and the indicator field.

As an example, a Cyclic Redundancy Check (CRC) value of a DCI message (DCI message CRC) is scrambled with a specific RNTI or code point that gives which subframe in time the corresponding downlink assignment or uplink grant is valid for. More generally, it can be envisioned that the DCI message CRC can be scrambled with M_{scramb} different scrambling codes thus conveying log 2(M_{scramb}), the total number of bits (in CIF but DCI message CRC scrambling) is then the number of bits if the CIF plus log 2(M_{scramb}). Instead of scrambling M_{scramb} different CRC polynomials could be used, however, this method is less preferable since complexity increases.

Herein it is assumed that the CIF comprises 3 bits. But if it is in the user equipment specific search space the number of CIF could be changed if not enough CIF code points exist to cover all carriers and subframes. Furthermore, PDCCH scrambling may be used to increase the number of code points.

In some embodiments, in which the message is a DCI message, a further bit field may be added to an existing DCI format. Such further bit field indicates which subframe the downlink assignment or uplink grant is valid for on a cross-scheduled carrier. The cross-scheduled carrier is indicated by the CIF.

### Action 703

This action corresponds to action 204.

The radio base station 110 sends and the user equipment 120 receives the message. As an example, the message is sent on PDCCH. The message may be indicating scheduling information to the user equipment 120. As an example, the scheduling information is used by the user equipment 120 for determining when and how a downlink transmission is to be received. As another example, the scheduling information is used by the user equipment 120 for determining when and how an uplink transmission is to be transmitted.

With reference to FIG. 8, a schematic block diagram of the radio base station 110 configured to perform the actions above is shown. The radio base station 110 may be configured to schedule a transmission to be transmitted between a user equipment 120 and the radio base station 110. The radio base station 110 is configured to operate an aggregated carrier in a subframe structure comprising a plurality of subframes. The aggregated carrier is configured to comprise a plurality of carriers for serving the user equipment 120.

In some embodiments of the radio base station 110, the radio base station 110 further is configured to operate a plurality of cells. Each cell is operated on a respective carrier of said plurality of carriers.

In some embodiments of the radio base station 110, the radio base station 110 is an evolved-NodeB.

The radio base station 110 comprises a scheduler 810 configured to encode information about a subframe out of said plurality of subframes and a carrier out of said plurality of carriers into a message, such as a DCI message, indicating scheduling information to the user equipment 120, thereby being configured to schedule the transmission on the subframe and the carrier.

In some embodiments of the radio base station 110, the scheduler 810 further is configured to include a string of bits indicating a combination of the subframe and the carrier into the message.

In some embodiments of the radio base station 110, the message is a downlink control information message comprising an indicator field, such as a carrier indicator field. Moreover, the scheduler 810 may further be configured to encode at least a portion of the string of bits into the indicator field.

In some embodiments of the radio base station 110, the message comprises a checksum. Furthermore, the scheduler 810 may further be configured to encode at least a portion of the string of bits into the checksum.

In some embodiments of the radio base station 110, a specific user equipment identifier is used to encode said at least a portion of the string of bits into the checksum. Thus, the scheduler 810 may further be configured to encode the specific user equipment identifier into said at least a portion of the string of bits.

In some embodiments of the radio base station 110, the scheduler 810 further is configured to configure mapping from the string of bits to the combination of the subframe and the carrier.

The scheduler 810 may comprise a processing circuit, such as a processing unit, a processor, an application specific integrated circuit (ASIC), a field-programmable gate array (FPGA) or the like. As an example, a processor, an ASIC, an FPGA or the like may comprise one or more processor kernels. In some embodiments, the scheduler 810 may be a software module.

The radio base station 110 further comprises a transmitter 820 configured to send the message to the user equipment 120.

In some embodiments of the radio base station 110, the radio base station 110 further comprises a receiver 830 configured to receive transmissions from the user equipment 120. As an example, the transmissions may be one or more uplink transmissions comprising data, control information or the like.

In some embodiments of the radio base station 110, the radio base station 110 may further comprise a memory 840 for storing software to be executed by, for example, the scheduler. The software may comprise instructions to enable the scheduler to perform the method in the radio base station 110 as described above in conjunction with FIG. 7. The memory 840 may be a hard disk, a magnetic storage medium, a portable computer diskette or disc, flash memory, random access memory (RAM) or the like. Furthermore, the memory may be an internal register memory of a processor.

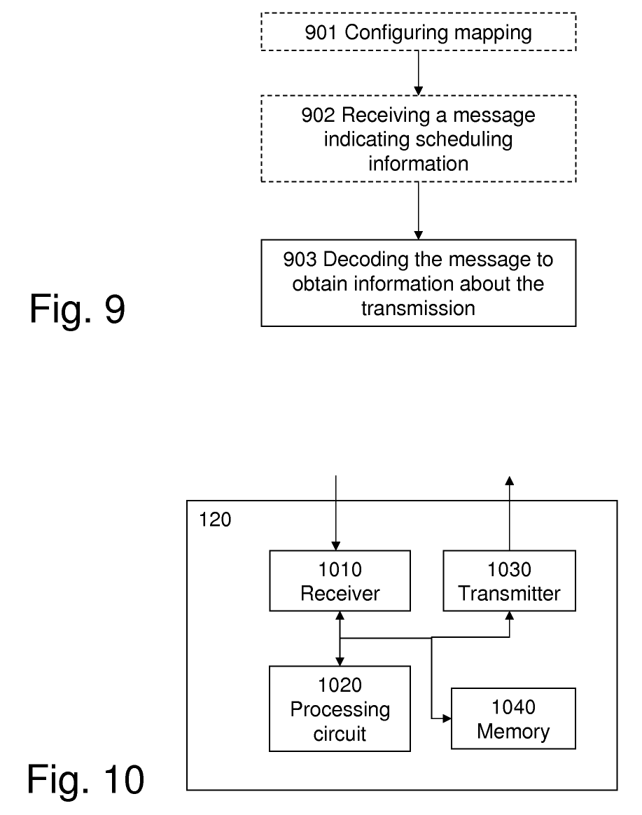

Referring to FIG. 9, an exemplifying, schematic flow chart is shown. The exemplifying flow chart illustrates the methods of FIG. 2 when seen from the user equipment 120. As mentioned above, the user equipment 120 may perform a method for obtaining information about a transmission to be transmitted between the user equipment 120 and the radio base station 110. As above, the user equipment 120 is served on an aggregated carrier in a subframe structure comprising a plurality of subframes. As mentioned, the aggregated carrier comprises a plurality of carriers.

The following actions may be performed. Notably, in some embodiments of the method the order of the actions may differ from what is indicated below.

### Action 901

This action corresponds to action 202.

In some embodiments, the user equipment 120 configures mapping from the string of bits to the subframe and the carrier. The mapping may for example be received from the radio base station 110, be preconfigured according to standard tables and/or the like. See also Table 1 and/or 2.

### Action 902

This action corresponds to action 204.

The radio base station 110 sends and the user equipment 120 receives the message. As an example, the message is sent on PDCCH. The message may be indicating scheduling information to the user equipment 120. As an example, the scheduling information is used by the user equipment 120 for determining when and how a downlink transmission is to be received. As another example, the scheduling information is used by the user equipment 120 for determining when and how an uplink transmission is to be transmitted.

### Action 903

This action corresponds to action 205.

The user equipment 120 decodes the message to obtain the information about the transmission. The information is indicative of a subframe out of said plurality of subframes and a carrier out of said plurality of carriers. The transmission is scheduled on said subframe and said carrier.

In FIG. 10, a schematic block diagram of the user equipment 120 configured to perform the actions above is shown. The user equipment 120 may be configured to obtain information about a transmission to be transmitted between the user equipment 120 and a radio base station 110. The user equipment 120 is configured to be served on an aggregated carrier in a subframe structure comprising a plurality of subframes. The aggregated carrier comprises a plurality of carriers.

In some embodiments of the user equipment 120, the user equipment 120 is configured to be served by a plurality of cells configured to be operated by the radio base station 110. Each cell is operated on a respective carrier of said plurality of carriers. The radio base station 110 further is configured to operate said plurality of cells.

In some embodiments of the user equipment 120, the indicator field is a carrier indicator field for indicating the subframe and the carrier.

The user equipment 120 comprises a receiver 1010 configured to receive, from the radio base station 110, a message indicating scheduling information.

Furthermore, the user equipment 120 comprises a processing circuit 1020 configured to decode the message to obtain the information about the transmission. The information is indicative of a subframe out of said plurality of subframes and a carrier out of said plurality of carriers on which the transmission is scheduled.

In some embodiments of the user equipment 120, the processing circuit 1020 further is configured to decode the message to obtain a string of bits indicating a combination of the subframe and the carrier.

In some embodiments of the user equipment 120, the message is a downlink control information message comprising an indicator field and wherein the processing circuit 1020 further is configured to decode the indicator field to obtain at least a portion of the string of bits.

In some embodiments of the user equipment 120, the message comprises a checksum and wherein the processing circuit 1020 further is configured to decode the checksum to obtain at least a portion of the string of bits.

In some embodiments of the user equipment 120, a specific user equipment identifier is used to encode said at least a portion of the string of bits into the checksum. Thus, the processing circuit may further be configured to decode the checksum to obtain at least a portion of the string of bits.

In some embodiments of the user equipment 120, the user equipment 120 further is configured to configure mapping from the string of bits to the combination of the subframe and the carrier from the radio base station 110. As an example, the processing circuit 1020 may be configured to configure the mapping.

The processing circuit 1020 may be a processing unit, a processor, an application specific integrated circuit (ASIC), a field-programmable gate array (FPGA) or the like. As an example, a processor, an ASIC, an FPGA or the like may comprise one or more processor kernels.

In some embodiments of the user equipment 120, the user equipment 120 may further comprise a transmitter 1030 configured to transmit transmissions to the radio base station 110. As an example, the transmission may be uplink transmissions comprising data, control information or the like.

In some embodiments of the user equipment 120, the user equipment 120 may further comprise a memory 1040 for storing software to be executed by, for example, the processing circuit. The software may comprise instructions to enable the processing circuit to perform the method in the user equipment 120 as described above in conjunction with FIG. 9. The memory 1040 may be a hard disk, a magnetic storage medium, a portable computer diskette or disc, flash memory, random access memory (RAM) or the like. Furthermore, the memory may be an internal register memory of a processor.

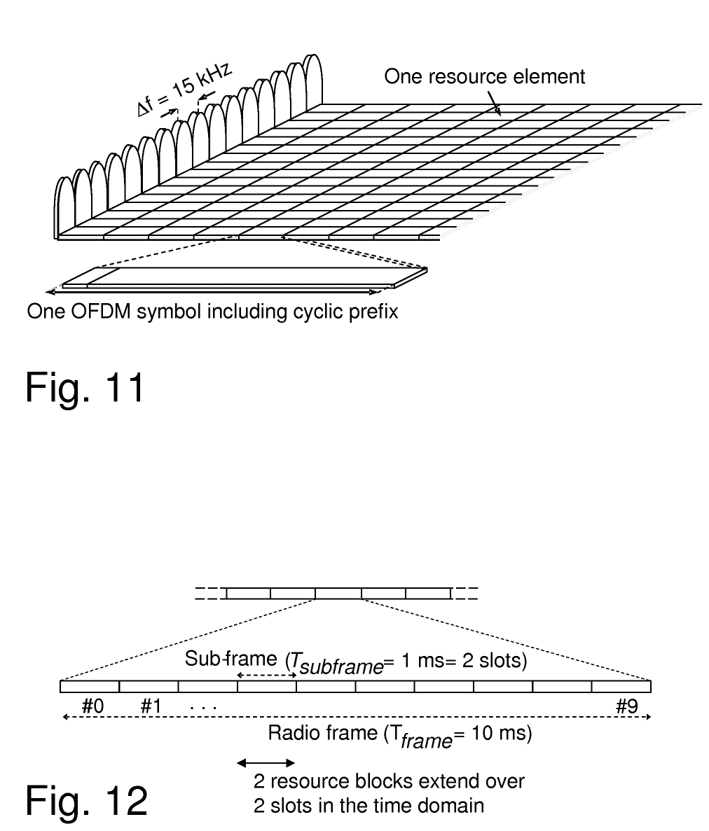

With reference to FIG. 11-14, some features and/or properties of an LTE system are described in more detailed such as to provide additional background information.

LTE uses OFDM (Orthogonal Frequency Division Multiplexing) in the downlink and DFT-spread OFDM (Discrete Fourier Transform spread Orthogonal Frequency Division Multiplexing) in the uplink. The basic LTE downlink physical resource can thus be seen as a time-frequency grid as illustrated in FIG. 11, where each resource element corresponds to one OFDM subcarrier during one OFDM symbol interval.

In the time domain, LTE downlink transmissions are organized into radio frames of 10 ms, each radio frame consisting of ten equally-sized subframes of length T_{subframe}=1 ms as seen in FIG. 12.

Furthermore, the resource allocation in LTE is typically described in terms of resource blocks, where a resource block corresponds to one slot (0.5 ms) in the time domain and 12 contiguous subcarriers in the frequency domain. Resource blocks are numbered in the frequency domain, starting with 0 from one end of the system bandwidth.

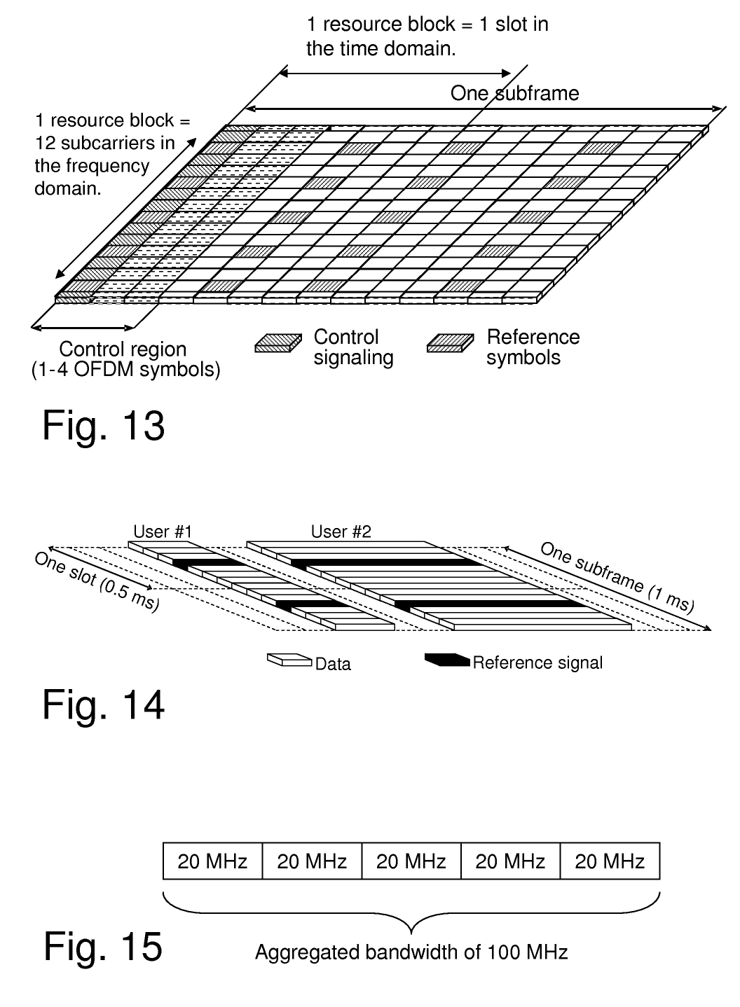

Downlink transmissions are dynamically scheduled, i.e., in each subframe (or transmission time interval, TTI) the base station transmits control information about to which user equipments data is transmitted and upon which resource blocks the data is transmitted, in the current downlink subframe. This control signaling is typically transmitted in the first 1, 2, 3 or 4 OFDM symbols in each subframe. A downlink system with 3 OFDM symbols as control is illustrated in FIG. 13.

To transmit data in the uplink the user equipment has to have been assigned an uplink resource for data transmission, on the Physical Uplink Shared Channel (PUSCH). In contrast to a data assignment in downlink, in uplink the assignment must always be consecutive in frequency, this to retain the single carrier property of the uplink as illustrated in FIG. 14.

In FIG. 15, carrier aggregation as mentioned in the background section is schematically illustrated. In the example of FIG. 15, five component carriers are aggregated. Each of the five component carriers utilizes a 20 MHz frequency band. Hence, the aggregated carrier may utilize a 100 MHz frequency band.

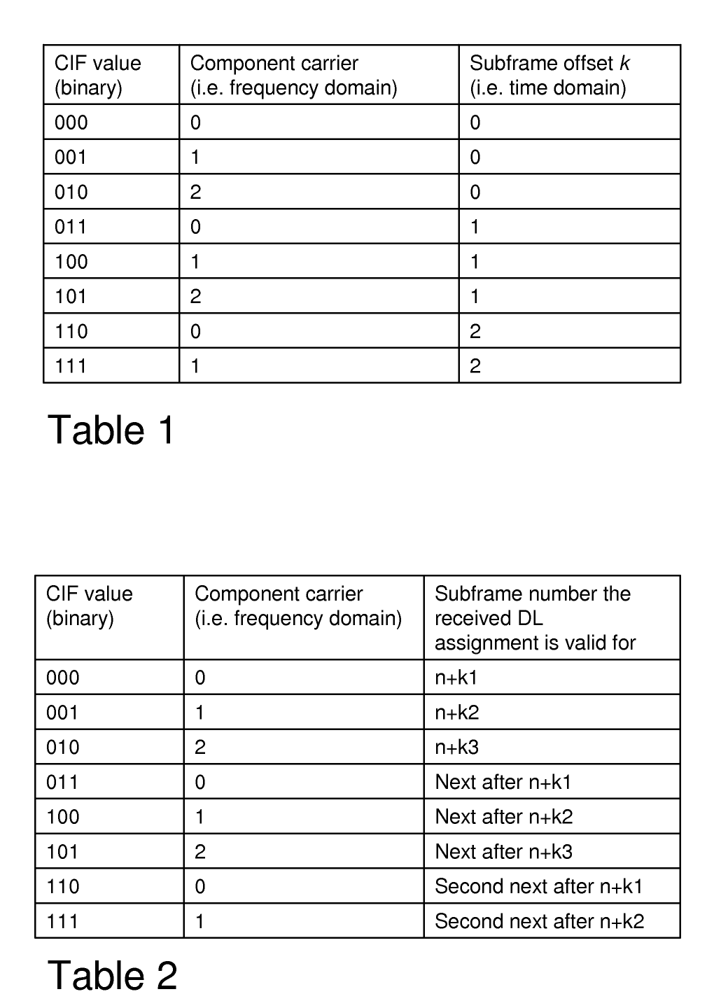

Now returning to the HetNets mentioned in the background section. Hetero-geneous network (HetNet) is a network that consist of a mix of different types of network nodes that generally have different coverage and transmit power. Examples of HetNet network is a network that contains both macro and pico cells. An example of a HetNet deployment is given in FIG. 17 which will be discussed in some more detail after this section. LTE Rel-8 supports the possibility to deploy HetNet networks.

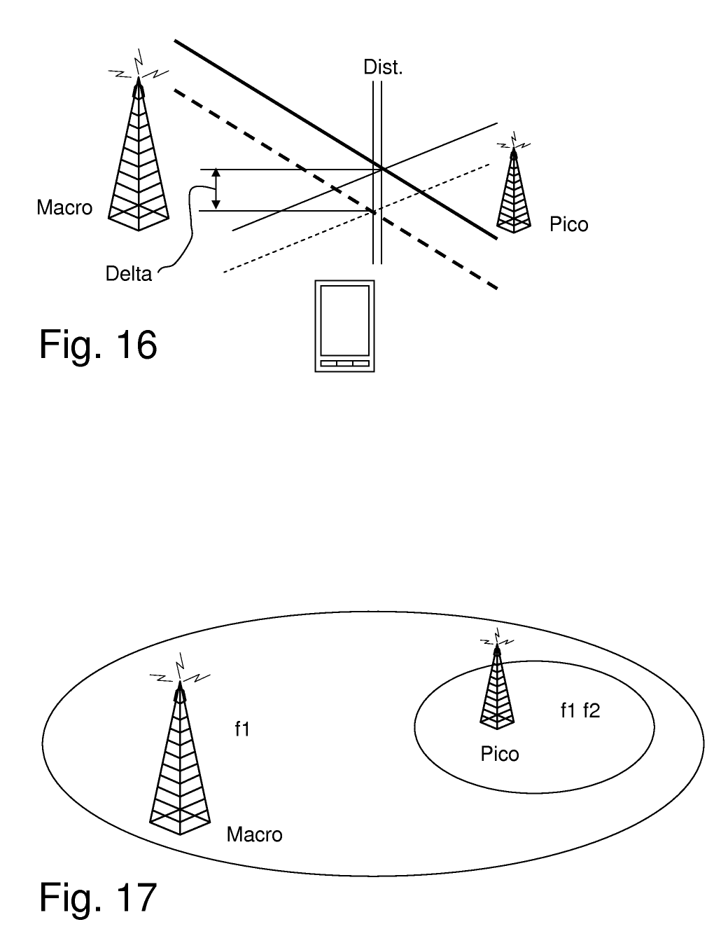

Within LTE Rel-10 and HetNets the discussion has focused around cell range expansion CRE for HetNets. With CRE the cell selection criteria is generalized so that the user equipment does not necessarily connect to the cell with the largest DL power. In the extreme case it is so that the user equipment attaches to the cell that it has the best UL pathloss compared to in Rel-8/9 where the cell selection criteria is the cell with the largest received downlink power. This is illustrated in FIG. 16 where a user equipment is located in a CRE area. In FIG. 16 the dashed black arrow and the solid black arrow corresponds to the received TX power in the user equipment from the macro and pico cell correspondingly, further the two dashed blue lines corresponds to the 1/UL pathloss.

If the cell selection criteria based on DL transmission power is used, the user equipment will change between pico and macro cell, or pico base station and macro base station, at a point where a solid thick arrow and a solid thin arrow crosses each other. If instead the cell selection criteria are based purely on UL pathloss then the user equipment will change cell at the point where the two dashed lines, one thick and one thin dashed line, crosses each other. The difference between these two cases corresponds to a power delta, denoted delta. The delta also corresponds to an extended distance, denoted dist, from the pico cell is available as shown in FIG. 16. In general, the cell selection criteria is somewhere in between these two.

With reference to the above mentioned FIG. 17, an exemplifying HetNet is shown. The HetNet comprises a macro base station, denoted macro, and a pico base station, denoted pico. As an example, the macro base station utilizes only one carrier f1. The pico base station utilizes, as an example, a first and a second carrier f1, f2. In other examples, also the macro base station utilizes two carriers, such as carriers f1, f2. Typically, transmit power of the macro base station is greater than transmit power of the pico base station. At the pico base station, the second carrier f2 cross-schedules the first carrier f1, since the macro does not operate any carrier on f2. Thus, control signalling on the second carrier will experience less interference, from the macro base station, than any control signalling potentially being transmitted on f1.

As explained above in conjunction with FIG. 3, the tool to provide cross carrier scheduling is the Carrier Indicator Field (CIF). The CIF consists of three bits attached to the DCI message which points to that component carrier the corresponding shared channel is located at. For a downlink assignment the CIF points to the component carrier carrying the PDSCH whereas for an uplink grant the three bits are used to address the component carrier conveying Physical Uplink Shared CHannel (PUSCH). For simplicity this field is always three bits, even though it could be optimized depending on the number of component carriers a user equipment is configured with. However, the potential overhead savings are minor and have therefore not been pursued.

Even though embodiments of the various aspects have been described, many different alterations, modifications and the like thereof will become apparent for those skilled in the art. The described embodiments are therefore not intended to limit the scope of the present disclosure.

1-36. (canceled)

37. A method in a radio base station for scheduling a transmission between a user equipment and the radio base station to occur during one of a plurality of subframes in a subframe structure and on one of a plurality of carriers that are aggregated together for serving the user equipment, the method comprising:
encoding into a message scheduling information that indicates during which of said subframes and on which of said carriers the transmission is scheduled to occur; and
sending the message to the user equipment.

38. The method according to claim 37, wherein said encoding comprises encoding into the message a combination of bit values for a string of bits that indicates during which of said subframes and on which of said carriers the transmission is scheduled to occur.

39. The method according to claim 38, wherein the message is a downlink control information message and wherein said encoding comprises encoding at least a portion of the string of bits into an indicator field of the message.

40. The method according to claim 38, wherein said encoding comprises encoding at least a portion of the string of bits into a checksum included in the message.

41. The method according to claim 40, wherein said encoding comprises using a specific user equipment identifier to encode said at least a portion of the string of bits into the checksum.

42. The method according to claim 38, wherein the method further comprises configuring a mapping that maps different combinations of bit values for a string of bits to different combinations of said subframes and said carriers, and wherein said encoding comprises encoding into the message the combination of bit values that is mapped to the subframe during and the carrier on which the transmission is scheduled to occur.

43. The method according to claim 37, wherein the radio base station is configured to operate a plurality of cells on respective ones of said carriers, and wherein the user equipment is served by said plurality of cells.

44. The method according to claim 37, wherein the transmission is an uplink transmission to be transmitted by the user equipment and to be received by the radio base station.

45. The method according to claim 37, wherein the transmission is a downlink transmission to be transmitted by the radio base station and to be received by the user equipment.

46. The method according to claim 37, wherein the radio base station is an evolved-NodeB.

47. The method according to claim 37, wherein said sending comprises sending the message to the user equipment during a different subframe and on a different carrier than the subframe during and the carrier on which the transmission is scheduled to occur.

48. A radio base station configured to schedule a transmission between a user equipment and the radio base station to occur during one of a plurality of subframes in a subframe structure and on one of a plurality of carriers that are aggregated together for serving the user equipment, the radio base station comprising:
a scheduler configured to encode into a message scheduling information that indicates during which of said subframes and on which of said carriers the transmission is scheduled to occur; and
a transmitter configured to send the message to the user equipment.

49. The radio base station according to claim 48, wherein the scheduler is configured to encode into the message a combination of bit values for a string of bits that indicates during which of said subframes and on which of said carriers the transmission is scheduled to occur.

50. The radio base station according to claim 49, wherein the message is a downlink control information message, and wherein the scheduler is configured to encode at least a portion of the string of bits into an indicator field of the message.

51. The radio base station according to claim 49, wherein the scheduler is configured to encode at least a portion of the string of bits into a checksum included in the message.

52. The radio base station according to claim 51, wherein the scheduler is configured to use a specific user equipment identifier to encode said at least a portion of the string of bits into the checksum.

53. The radio base station according to claim 49, wherein the scheduler is configured to configure a mapping that maps different combinations of bit values for a string of bits to different combinations of said subframes and said carriers, and to encode into the message the combination of bit values that is mapped to the subframe during and the carrier on which the transmission is scheduled to occur.

54. The radio base station according to claim 48, wherein the radio base station is configured to operate a plurality of cells on respective ones of said carriers.

55. The radio base station according to claim 48, wherein the radio base station is an evolved-NodeB.

56. The radio base station according to claim 48, wherein the transmitter is configured to send the message to the user equipment during a different subframe and on a different carrier than the subframe during and the carrier on which the transmission is scheduled to occur.

57. A method in a user equipment for obtaining information regarding a transmission scheduled to occur between the user equipment and a radio base station during one of a plurality of subframes in a subframe structure and on one of a plurality of carriers that are aggregated together for serving the user equipment, the method comprising:
receiving a message from the radio base station; and
decoding the message to obtain scheduling information that indicates during which of said subframes and on which of said carriers the transmission is scheduled to occur.

58. The method according to claim 57, wherein said decoding comprises decoding the message to obtain a combination of bit values for a string of bits that indicates during which of said subframes and on which of said carriers the transmission is scheduled to occur.

59. The method according to claim 58, wherein the message is a downlink control information message, and wherein said decoding comprises decoding an indicator field of the message to obtain at least a portion of the string of bits.

60. The method according to claim 58, wherein said decoding comprises decoding a checksum included in the message to obtain at least a portion of the string of bits.

61. The method according to claim 60, wherein said decoding comprises using a specific user equipment identifier to decode the checksum.

62. The method according to claim 58, wherein the method further comprises configuring a mapping that maps different combinations of bit values for a string of bits to different combinations of said subframes and said carriers, and wherein said decoding comprises identifying the combination of said subframes and said carriers mapped to the combination of bit values obtained from decoding the message.

63. The method according to claim 57, wherein the radio base station operates a plurality of cells on respective ones of said carriers, and wherein the user equipment is served by said plurality of cells.

64. The method according to claim 57, wherein the transmission is an uplink transmission to be transmitted by the user equipment and to be received by the radio base station.

65. The method according to claim 57, wherein the transmission is a downlink transmission to be transmitted by the radio base station and to be received by the user equipment.

66. The method according to claim 57, wherein said decoding comprises decoding the message to obtain a carrier indicator field that indicates during which of said subframes and on which of said carriers the transmission is scheduled to occur.

67. The method according to claim 57, wherein said receiving comprises receiving the message during a different subframe and on a different carrier than the subframe during and the carrier on which the transmission is scheduled to occur.

68. A user equipment configured to obtain information regarding a transmission scheduled to occur between the user equipment and a radio base station during one of a plurality of subframes in a subframe structure and on one of a plurality of carriers that are aggregated together for serving the user equipment, the user equipment comprising:
a receiver configured to receive a message from the radio base station; and
a processing circuit configured to decode the message to obtain scheduling information that indicates during which of said subframes and on which of said carriers the transmission is scheduled to occur.

69. The user equipment according to claim 68, wherein the processing circuit is configured to decode the message to obtain a combination of bit values for a string of bits that indicates during which of said subframes and on which of said carriers the transmission is scheduled to occur.

70. The user equipment according to claim 69, wherein the message is a downlink control information message, and wherein the processing circuit is configured to decode an indicator field of the message to obtain at least a portion of the string of bits.

71. The user equipment according to claim 69, wherein the processing circuit is configured to decode a checksum included in the message to obtain at least a portion of the string of bits.

72. The user equipment according to claim 71, wherein the processing circuit is configured to use a specific user equipment identifier to decode the checksum.

73. The user equipment according to claim 69, wherein the user equipment is further configured to configure a mapping that maps different combinations of bit values for a string of bits to different combinations of said subframes and said carriers, and wherein said processing circuit is configured to identify the combination of said subframes and said carriers mapped to the combination of bit values obtained from decoding the message.

74. The user equipment according to claim 68, wherein the user equipment is configured to be served by a plurality of cells operated by the radio base station on respective ones of said carriers.

75. The user equipment according to claim 68, wherein the processing circuit is configured to decode the message to obtain a carrier indicator field that indicates during which of said subframes and on which of said carriers the transmission is scheduled to occur.

76. The user equipment according to claim 68, wherein the receiver is configured to receive the message during a different subframe and on a different carrier than the subframe during and the carrier on which the transmission is scheduled to occur.
